(19) United States
(12) Patent Application Publication
(10) Pub. No.: US 2005/0207590 A1
(43) Pub. Date: Sep. 22, 2005

(54) Method of reproducing audio sound with ultrasonic loudspeakers

(76) Inventors: Wolfgang Niehoff, Wedemark (DE); Vladimir Gorelik, Hannover (DE); Oliver Gelhard, Hannover (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/113,163

(22) Filed: Apr. 22, 2005

Related U.S. Application Data
(63) Continuation of application No. 10/009,703, filed on Mar. 5, 2002, now abandoned.

(30) Foreign Application Priority Data
Apr. 30, 1999 (DE) 199 19 980.9

(51) Int. Cl. H04B 3/00

(52) U.S. Cl. 381/77; 381/79

(57) ABSTRACT

A method of reproducing audio sound with ultrasonic loudspeakers and a design of the ultrasonic loudspeakers and use thereof is disclosed. The method and related apparatus, is for reproducing audio sound by means of an ultrasound-producing device, wherein the audio signal to be reproduced is linked by side band amplitude modulation to a carrier signal in the ultrasonic frequency range, wherein there are provided elements for subjecting the modulated ultrasonic signal to dynamic error compensation and the compensated ultrasonic signal is possibly subjected to frequency characteristic linearization and is then passed to an ultrasonic transducer (loudspeaker), wherein there are provided elements for reducing the amplitude of the ultrasonic carrier signal (carrier reduction).

### CROSS-REFERENCE TO RELATED APPLICATIONS

This application is a continuation application of U.S. patent application Ser. No. 10/009,703 filed Mar. 5, 2002, which claims priority of International Application No. PCT/EP00/03931, filed May 2, 2000 and German Application No. 199 19 980.9, filed Apr. 30, 1999, the complete disclosures of which are hereby incorporated by reference.

### BACKGROUND OF THE INVENTION

a) Field of the Invention

The invention concerns a method of reproducing audio sound with ultrasonic loudspeakers and a design of the ultrasonic loudspeakers and use thereof.

b) Description of the Related Art

J. Acoust. Soc. Am., Vol 73, No 5, May 1983 “The audio spotlight: An application of nonlinear interaction of sound waves to a new type of loudspeaker design” already discloses constructing a loudspeaker comprising a plurality of ultrasonic radiating devices. By means of such ultrasonic radiating devices, audio sound can be emitted in a frequency range in which the audio sound itself can no longer be perceived by the human ear. An audible sound is produced by virtue of non-linear effects in the air, with a high level of acoustic pressure and the superimposition of two ultrasonic waves. The frequency of the ultrasound, which is high in comparison with conventional audio signals, provides that emission of the sound takes place in a strongly spatially directed fashion by virtue of its short wavelength and the transducer dimensions of the ultrasonic radiating device, which are large in comparison therewith. The frequency dependency of the directional characteristic of conventional loudspeakers—spherical radiating devices at low frequencies and directional radiating devices at high frequencies—scarcely occurs in the case of an ultrasonic loudspeaker.

In addition, a different effect is described in the conference volume AES, 26-29 Sep. 1998, San Francisco, Calif., “The use of Airborne Ultrasonics for Generating Audible Sound Beams”. Also described therein are considerations relating to the production of an audible sound based on the emission of the audio sound by means of ultrasound.

Furthermore the phenomenon of producing sound waves by means of ultrasonic radiating devices is also known from the journal Audio, issue 8, 1997, pages 7-8. It is described therein that a first signal at 200 kHz is emitted by means of a loudspeaker system and the loudspeaker system emits a second signal at the same frequency of 200 kHz, the second signal being modulated with the audio sound signal (20 Hz to 20 kHz). Due to the non-linear behavior of air, when the two signals are superimposed, a mixed result is produced, so that the difference of the two signals from each other is audible in the form of acoustic sound.

As further state of the art, reference may be made to: U.S. Pat. No. 4,872,148, U.S. Pat. No. 4,439,642, U.S. 4,439,641, U.S. Pat. No. 4,409,441, U.S. Pat. No. 4,280,204, U.S. Pat. No. 4,199,246, WO-A-85/02748, EP-A-0 164 342, EP-A-0 154 256, CA 1 274 619, CA 1 215 164, CA 1 195 420, CA 1 120 578, AU-A-28287/77, AU-A-510193, WO98/39209, WO98/02976, WO98/02977, WO98/02978, WO98/26405, GB-A-2 225 426, DE-A-27 39 748, US-A-5,375,099, CA 1 274 619, DE-A-196 28 849, U.S. Pat. No. 1,616,639, U.S. Pat. No. 1,951,669, U.S. Pat. No. 2,461,344 and U.S. Pat. No. 3,398,810. Further features of ultrasonic loudspeakers are described in the above-mentioned literature items.

Although there have been various approaches adopted in respect of ultrasonic loudspeakers, hitherto such a product has not been able to establish itself on the market. That is also related to the fact that, in spite of the particular properties of ultrasonic loudspeakers, some problems arise, which are in part related to the essence of ultrasound propagation, but which on the other hand are also related to the ultrasonic radiating device itself.

### OBJECT AND SUMMARY OF THE INVENTION

The primary object of the present invention is to improve a method of reproducing audio sound and an ultrasonic loudspeaker, in comparison with the previous approaches, so that sound reproduction of high quality is possible. In accordance with the invention, a method of reproducing audio sound by an ultrasound-producing device comprises the steps of linking the audio signal to be reproduced by side band amplitude modulation to a carrier signal in the ultrasonic frequency range, subjecting the modulated ultrasonic signal to dynamic error compensation, subjecting the compensated ultrasonic signal to frequency characteristic linearization and then passing the signal to an ultrasonic transducer and reducing the amplitude of the ultrasonic carrier signal at the transducer.

The method according to the invention combines low-frequency audio sound with the strong directional characteristic of ultrasound. The directional characteristic of the loudspeaker is thus virtually independent of the signal frequency. To understand the invention and the essence thereof, attention is to be directed to the following: Mathematically, it is possible to show with formulae in respect of non-linear acoustics that, with a high level of acoustic pressure (p>110 dB at 40 kHz), as a result of the non-linearity of the medium air, new waves occur when a plurality of waves interact with each other. The frequencies of those waves correspond to the sum and the difference frequency of the original waves and multiples thereof (n·ω₁±m·ω₂ wherein ω₁ and ω₂ are frequencies of the initiated sound waves (sounds) and n and m are integers). The sum and difference frequencies occur in each frequency range. Marked advantages over conventional loudspeakers arise in the ultrasonic range insofar as it is possible to implement a very strongly directional characteristic of the transducers and this lies outside the range of human hearing. In that case the initiating signals—that is to say the ultrasonic waves—are inaudible.

If for example a first sound at a frequency of 200 kHz and a second sound at a frequency of 201 kHz are radiated at a high level of acoustic pressure into the air, then sum and difference sounds occur in the superimposition zone of the two sounds. The first sum sound (f=200 kHz+201 kHz=401 kHz) is not audible. To produce audible sound use is made of the first difference sound (f=200 kHz−201 kHz=1 kHz) (FIG. 4). That difference sound is much louder than all other sounds which occur in the interaction situation. Sum and difference sounds only occur in a non-linear medium such as air as distortion products.

In that case, the difference sounds produced have the property that propagation of the difference sounds (secondary sound) occurs in the direction of the ultrasound to be produced (initiating sounds, primary sound). Furthermore the difference sounds are only audible in the ultrasound range, that is to say the directional characteristic of the difference sounds corresponds to that of the ultrasound. Finally the acoustic pressure of the difference sounds rises with the frequency of the ultrasound.

In terms of technical implementation of an ultrasonic loudspeaker according to the invention, firstly on the one hand the audio signal which is to be reproduced and which is still of a low frequency is subjected to frequency characteristic linearization (FIGS. 1 and 2). That signal is then linked by double side-band amplitude modulation to a carrier signal in the ultrasonic frequency range. That ultrasonic signal is then subjected to a dynamic (error compensation (compression)) procedure, the compressed signal is subjected to a second frequency characteristic linearization and that signal is in turn passed to the ultrasonic loudspeaker.

As an alternative to the above-described procedure for forming the ultrasonic signal, instead of the double side-band amplitude modulation, it is possible to provide single side-band amplitude modulation, in which case the ultrasonic carrier is preferably suppressed by some dB, for example 12 dB (FIG. 2).

The ideal center frequency, that is to say the mean value between the ultrasonic carrier frequency and the side band frequency (range) of the radiated ultrasonic signal arises out of the intended use. In that respect two groups can be definitively stated: A. Use in the near range of up to about 50 cm; B. Use at a spacing of more than 50 cm up to remote acoustic irradiation.

Different demands in terms of the center frequency can be derived from that range subdivision. The level of the audible acoustic pressure crucially depends on the acoustic pressure of the ultrasonic signal, the non-linearity parameter of the medium, the frequency of the audio signal produced and the spacing in relation to the source and the attenuation effect of the medium. The difference frequency wave DFW—therefore the audible sound—increases with increasing spacing relative to the source. Due to the attenuation effect for the ultrasonic wave in the air, the greatest acoustic pressure is attained at a given distance, until, with the distance becoming greater, the level falls again as a consequence of attenuation. Attenuation of ultrasound in the air in turn depends on the ultrasonic frequency. The higher the frequency is, the correspondingly higher also is the level of absorption of ultrasound in air.

For practical uses, this means that, for uses at a spacing of greater than 50 cm up to some meters, it is possible to specify an ideal frequency range of about 40 kHz to 500 kHz (or more). The frequency range on the one hand is selected to be sufficiently high in order to produce a DFW as effectively as possible and to ensure an adequate frequency distance in relation to the audible sound, while on the other hand being sufficiently low that attenuation by the air does not have an excessive influence on the audio sound. A further criterion is the directional characteristic of the ultrasonic radiating device. The higher the radiated frequency, the correspondingly more directional is the irradiation effect.

A higher frequency is appropriate for the near range (less than 50 cm) for air absorption is of negligible magnitude in the near range while the dimensions of the ultrasonic transducer, depending on the respective use involved, are so small that a stronger directional effect is not achieved by virtue of the configuration of the transducer, but can only be embodied by increasing the ultrasonic frequency.

The frequency shift of the low-frequency signal (speech, music, noises, tones) in the ultrasonic range is effected by amplitude modulation. In that case there is a carrier signal as well as an upper and a lower side band which contain the modulated information. With a high acoustic pressure the carrier signal becomes for example 200 kHz and the lower side band is radiated by way of a transducer and superimposed in the air. In that situation, the non-linear characteristic of the air gives rise to a signal whose frequency corresponds to the difference of the carrier and side band frequency. The higher the frequencies of the radiated sounds at a constant amplitude are, the correspondingly louder are the difference sounds produced. The acoustic pressure of the difference sounds rises quadratically with the difference frequency of the radiated ultrasonic sounds. By virtue of a high ultrasonic frequency, the directional effect which can be achieved can be maximized and the frequency distance of the radiated ultrasound in relation to the range of human hearing can be increased.

The acoustic pressure of the difference frequencies arises inter alia out of the product of the signals to be mixed. When an amplitude-modulated signal is emitted, the carrier is also radiated at full height, in the case of a modulation break, that is to say, when no signal is applied at the modulator. The amplitude of the carrier signifies a constant noise loading for the ears and a permanent electrical loading of the transducers. With conventional amplitude modulation the amplitude of a side band is mxA_{T}/2 (with m=modulation index and A_{T}=carrier amplitude). The carrier is continuously radiated and is of a greater amplitude than the side band which is modulated at the clock of the low frequency. These above-mentioned problems can be eliminated in a meaningful manner by the measures described hereinafter. A noise reduction can be achieved if the amplitude of the carrier is reduced, for example by means of a filter, or, and this is already done in the modulator, by partial carrier suppression, and at the same time the amplitude of the upper side band is increased. As a result the continuous level is reduced and the relative change in level which is related to the carrier, due to the modulation effect, becomes greater. For the situation of carrier suppression, the lower side band must be greatly suppressed in order to prevent mixing of the two side bands with each other, which would give rise to severe distortion effects. The above-described measure can also be generally referred to as “carrier reduction”.

If the carrier amplitude is modulated with the amplitude of the signal to be transmitted, no signal is emitted in the case of a modulation break. That then requires an additionally controlled compressor stage which compensates for amplitude errors which arise out of modulation of the carrier. Therefore, to eliminate the above-described problem, modulation of the carrier amplitude is effected at the clock of the signal to be modulated.

It is also possible to counter a problem as described hereinbefore, by effecting compression of the signal to be modulated, so that the signal is reduced in respect of its dynamics and thus in particular the quiet signal passages are raised in terms of their volume. The modulator can be operated in the optimum fashion in that way. After modulation the compression effect has to be compensated again by expansion in order to obtain the original dynamic. Good results could be achieved with the described compression of the modulation signal prior to modulation.

A further measure for eliminating the foregoing problem provides suppressing actuation of the transducers with the carrier signal in modulation breaks (muting) so that the modulator output signal is faded out when no input signal is applied.

The amplitude-modulated low frequency oscillation is radiated at a high level of acoustic pressure with a transducer. A difference frequency spectrum which corresponds to the spectrum of the low frequency occurs in the air due to the interaction between the carrier oscillation and the modulated side band. In order to achieve a low harmonic distortion factor, single side band modulation is particularly preferably appropriate. If the carrier is partially suppressed in conventional double side band amplitude modulation, suppression of the lower side band is essential because mixing of the two side bands with each other produces additional difference frequencies which make themselves undesirably noticeable in the form of a harmonic distortion factor.

With piezoelectric transducers however radiation of the modulated signal is of such a narrow-band nature that the lower side band is only very quietly reproduced. Mixing of the side bands with each other is negligible as a result, in terms of acoustic pressure. This however presupposes that the carrier is so loud that the mixture of carrier and side band gives a much louder signal than mixing of the side bands with each other. Accordingly, modulation is effected either in the form of conventional double side band amplitude modulation or in the form of single side band amplitude modulation in which the carrier is suppressed by for example 12 dB for further function optimization purposes.

The relationship between the electrical input signal of the piezoelectric transducers and the level of acoustic pressure of the difference sounds is not linear. In that respect, linear transmission can be achieved with a compensation circuit (dynamic compression).

Frequency-dependent amplitude errors in the transmission system are compensated by a frequency characteristic linearization procedure which is required in particular when using piezoelectric transducers with a strongly non-linear frequency characteristic. Distortion removal can be effected prior to modulation in the low-frequency range or after modulation in the ultrasonic range. Distortion removal after modulation enjoys the advantage that in that way the operating reserve of the modulator is not limited when a frequency range is raised.

The difference sound wave occurs in the radiated ultrasound cone. The cross-section of the cone in that case has an influence on the resulting audio frequency characteristic. The audible signal occurs at a boundary surface or interface which is put into the sound bean. In that situation the lower limit frequency depends on the cross-sectional area of the article put into the beam. In order to achieve a linear frequency characteristic for a reflector at a wall, distortion removal which is matched to the area of the reflector is necessary (area-related distortion removal).

The maximum in terms of the acoustic pressure occurs at a given distance from the ultrasonic source. It arises for different audio frequencies at different spacings. Therefore, a linear frequency characteristic can be set for a given distance only by virtue of a specific distance-related distortion removal effect. Accordingly signal processing must include a specific distance-dependent frequency characteristic distortion removal effect, for a linear frequency characteristic.

In order to produce a high ultrasound level, a relatively large number of transducers are connected in parallel. It was possible to find out in that respect that the arrangement of the transducers plays a great part. Thus, transducers are arranged as densely as possible on a plate so that the low-note response or reproduction of the loudspeaker is quieter than in the case of an arrangement in which the same number of transducers are arranged in an annular array.

The described analog amplitude modulation procedure can also be implemented digitally. In that case multiplication of a sine oscillation (carrier) by a low-frequency signal, partial suppression of the carrier and suppression of the lower side band are possible, with a digital signal processor component. Frequency characteristic contours can also be relatively easily implemented when using a digital signal processor.

The level of the audio acoustic pressure however also depends inter alia on the non-linearity parameter of the acoustically transmitting medium. For air the parameter ε=1.2. For the medium water ε=3.5. It was now possible to find that, in the case of a water-air bubble mixture, it is possible to specify an extreme value of ε over 5,000, which means that in comparison with the medium air, with a water/air mixture, the acoustic pressure can be increased by the factor of 4,000. In that way it is possible for example to produce a water/air mixture in a headset earpiece so that the water/air mixture medium is arranged between the ultrasonic radiating device and the listener and increases the acoustic pressure of the audio signal.

The audio acoustic pressure can also be still further increased by other measures. Due to the increasing steepening of the gradient of the wave front in the course of propagation, which is equivalent to the production of harmonics. In accordance with an energy balance sheet, the energy which is in the harmonics is not available for the difference sound wave. There is so-to-speak a flow of energy from the fundamental wave to the harmonics. If it is possible to brake that flow of energy, the audio acoustic pressure could be increased. A proposed implementation in that respect is as follows:

A sound-transmitting medium contains small cavities which, together with the material, affords a multiplicity of Helmholtz resonators. The resonators are tuned to the first harmonic of the signal and thereby brake the flow of energy to higher harmonics. If the cavities are filled with a non-linear medium, for example a liquid, it is possible by virtue of that measure to achieve a higher value for the non-linearity parameters, whereby the acoustic pressure of the difference sounds would be increased.

By means of that technology, it is possible to construct reflectors which passively amplify the acoustic pressure of the difference sounds.

By virtue of the described “attenuation plate”, for an ultrasonic loudspeaker which is fitted into the head support of a motor vehicle, it is possible to achieve a higher level of audio sound with at the same time reduced ultrasound. For cable-less headsets, it would be possible for inaudible ultrasound to be wirelessly transmitted and for the difference sounds to be brought to an adequate level by way of the above-described absorber.

Mathematically it is possible to show with formulae of non-linear acoustics that, with a high level of acoustic pressure (p>110 dB at 40 kHz), as a result of the non-linearity of the medium air, new waves occur when a plurality of waves interact with each other.

The frequencies of those waves correspond to the sum and the difference frequencies of the original waves and multiples thereof: (n*ω₁±m ω₂ with ω₁, ω₂: frequencies of the initiated sounds and n, m: integers).

The sum and difference frequencies occur in each frequency range. Marked advantages in comparison with conventional loudspeakers are afforded in the ultrasound range in which a very strong directional characteristic of the transducers can be embodied and which is outside the range of human hearing; the initiating signals are inaudible in that case.

### EXAMPLE

If a sound at a frequency of 200 kHz and a second sound at a frequency of 201 kHz are emitted into the air at a high level of acoustic pressure, sum and difference sounds occur in the superimposition zone of the two sounds. The first sum sound (f=200 kHz+201 kHz=401 kHz) is not audible. To produce audible sound, the first difference tone (f=200 kHz−201 kHz=1 kHz) is used. It is also much louder than all other sounds occurring in the interaction. It is only in a non-linear medium such as air that distortion products occur, which give sum and difference sounds.

Properties of the difference sounds produced:
propagation of the secondary sound (the difference sounds) occurs in the direction of the primary sound (the initiating sounds),
the secondary sound is only audible in the region of the primary sound, that is to say, the directional characteristic of the secondary sound corresponds to that of the primary sound, and
the acoustic pressure of the difference sounds rises with the frequency of the initiating sounds.

Technical implementation (embodiment of the invention by way of example):

### BRIEF DESCRIPTION OF THE DRAWINGS

In the drawings:

FIG. 1 illustrates in block diagram form a simplified realization of the ultrasonic loudspeaker;

FIG. 2 illustrates in block diagram form an improved circuit of the ultrasonic loudspeaker;

FIG. 3 illustrates in simplified block form the transmission portion realized with digital signal processing;

FIG. 4a illustrates in representation form the generation of intermodulation products when f1 and Δ is modulated with an f1 carrier signal (Δ being the audio signal);

FIG. 4b illustrates in representation form the generation of an audio sound wave from an ultrasonic transducer;

FIG. 5 is a block and representation form showing the resulting directional characteristics of the method;

FIG. 6a illustrates a pictorial representation of the sound as emanating from an imaginary source; and

FIG. 6b illustrates a pictorial representation showing the ability to differentiate between two sources in accordance with the invention.

### DESCRIPTION OF THE PREFERRED EMBODIMENTS

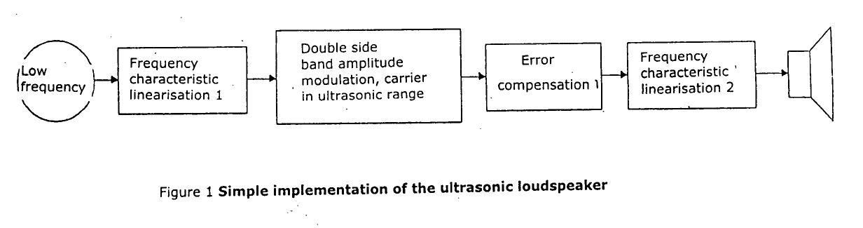

As can be seen from FIG. 1, firstly on the one hand the low-frequency audio signal is subjected to a frequency characteristic linearization procedure and then a double side band amplitude modulation procedure (and/or frequency and/or phase modulation), with the carrier frequency being in the ultrasonic range. Thereafter, dynamic compression or dynamic error compensation is possibly effected (in dependence on signal). That is then again followed by further frequency characteristic linearization and the signal which is then outputted is fed to an ultrasonic transducer.

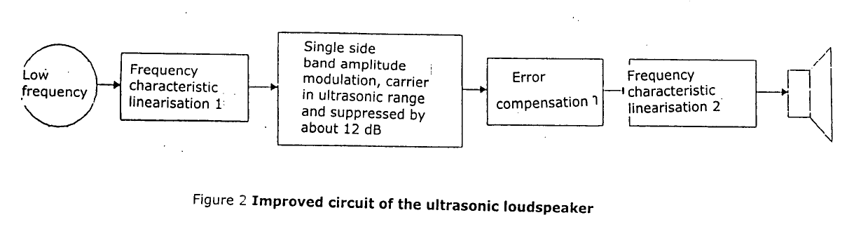

The circuit shown in FIG. 2 differs from that in FIG. 1 essentially in that, instead of double side band amplitude modulation, single side band amplitude modulation is effected, with the carrier being suppressed in the ultrasonic range by about 12 dB.

The ideal center frequency, that is to say the mean value between the ultrasonic carrier frequency and the side band frequency (range) of the radiated ultrasonic signal arises out of the intended use. In that respect two groups can be stated:
1. Use in the near range of up to about 50 cm;
2. Use at a spacing >50 cm and remote acoustic irradiation.

Different demands in terms of the center frequency can be derived from that range subdivision. The level of the audible acoustic pressure crucially depends on the acoustic pressure of the ultrasonic signal, the non-linearity parameter of the medium, the frequency of the audio signal produced and the spacing in relation to the source and the attenuation effect of the medium. The difference frequency wave increases with increasing spacing relative to the source. Due to the attenuation effect for the ultrasonic wave in the air, the greatest acoustic pressure is attained at a given distance, until, with the distance becoming greater, the level falls again as a consequence of attenuation. Attenuation of ultrasound in the air in turn depends on the frequency. The higher the frequency is, the correspondingly higher also is the level of absorption of ultrasound in air.

For practical uses, this means that, for uses at a spacing >50 cm up to some meters, it is possible to specify an ideal frequency range of about 80 kHz to 180 kHz. The frequency range on the one hand is selected to be sufficiently high in order to produce a DFW as effectively as possible and to ensure an adequate frequency distance in relation to the audible sound, while on the other hand being sufficiently low that attenuation by the air does not have an excessive influence on the audio sound. A further criterion is the directional characteristic of the ultrasonic radiating device. The higher the radiated frequency, the correspondingly more directional is the irradiation effect.

A higher frequency is appropriate for the near range for air absorption is of negligible magnitude in the near range while the dimensions of the ultrasonic transducer, depending on the respective use involved, are so small that a stronger directional effect is not achieved by virtue of the configuration of the transducer, but can only be embodied by increasing the ultrasonic frequency.

Frequency Shift of the Low-Frequency Signal

The frequency shift of the low-frequency signal (speech, music, noises, tones) into the ultrasonic range is effected by amplitude modulation. In that case there is a carrier signal as well as an upper and a lower side band which contain the modulated information.

With a high acoustic pressure the carrier signal becomes for example 200 kHz and the upper side band is radiated by way of a transducer and superimposed in the air. In that situation, the non-linear characteristic of the air gives rise to a signal whose frequency corresponds to the difference of the carrier and side band frequency. The higher the frequencies of the radiated sounds at a constant amplitude are, the correspondingly louder are the difference sounds produced. The acoustic pressure of the difference sounds rises quadratically with the difference frequency of the radiated ultrasonic sounds. By virtue of a high ultrasonic frequency, the directional effect which can be achieved can be maximized and the frequency distance of the radiated ultrasound in relation to the range of human hearing can be increased.

Inadequacy in Amplitude Modulation: Permanent Carrier Amplitude

The acoustic pressure of the difference frequencies arises inter alia out of the product of the signals to be mixed. When an amplitude-modulated signal is emitted, the carrier is also radiated at full height, in the case of a modulation break, that is to say, when no signal is applied at the modulator. The high amplitude of the carrier signifies a constant noise loading for the ears and a permanent electrical loading of the transducers. With conventional amplitude modulation the amplitude of a side band is m*A_{T}/2 (with m=modulation index and A_{T}=carrier amplitude). The carrier is continuously radiated and is of a greater amplitude than the side band which is modulated at the clock of the low frequency. Therefore the following measures are meaningful:

Carrier Reduction

A noise reduction can be achieved if the amplitude of the carrier is reduced, for example by means of a filter, or, and this is already done in the modulator, by partial carrier suppression, and at the same time the amplitude of the upper side band is increased. As a result the continuous level is reduced and the relative change in level which is related to the carrier, due to the modulation effect, becomes greater. For the situation of carrier suppression, the lower side band must be greatly suppressed in order to prevent mixing of the two side bands with each other, which would give rise to severe distortion effects.

Modulation of the Carrier Amplitude in the Clock of the Signal to be Modulated

If the carrier amplitude is modulated with the amplitude of the signal to be transmitted, no signal is emitted in the case of a modulation break. That then requires an additional controlled compressor stage which compensates for amplitude errors which arise out of modulation of the carrier.

Compression of the Modulation Signal Prior to Modulation

Compression of the signal to be modulated provides that the signal is reduced in respect of its dynamics and thus in particular the quiet signal passages are raised in terms of their volume. The modulator can be operated in the optimum fashion in that way. After modulation the compression effect has to be compensated again by expansion in order to obtain the original dynamic.

Muting

For suppressing actuation of the transducers with the carrier signal in modulation breaks the modulator output signal is faded out when no input signal is applied.

Practical Design of the Modulator

The amplitude-modulated low frequency oscillation is radiated at a high level of acoustic pressure with a transducer. A difference frequency spectrum which corresponds to the spectrum of the low frequency occurs in the air due to the interaction between the carrier oscillation and the modulated side band. In order to achieve a low harmonic distortion factor, single side band modulation is optimum. If the carrier is partially suppressed in conventional double side band amplitude modulation, suppression of the lower side band is essential because mixing of the two side bands with each other produces additional difference frequencies which make themselves noticeable in the form of a harmonic distortion factor.

With piezoelectric transducers however radiation of the modulated signal is of such a narrow-band nature that the lower side band is only very quietly reproduced. Mixing of the side bands with each other is negligible as a result, in terms of acoustic pressure. This however presupposes that the carrier is so loud that the mixture of carrier and side band gives a much louder signal than mixing of the side bands with each other.

Accordingly, modulation is effected either in the form of conventional double side band amplitude modulation or in the form of single side band amplitude modulation in which the carrier is suppressed by for example 12 dB for further function optimization purposes.

Dynamic Compression (Dynamic Error Compensation)

The relationship between the electrical input signal of the piezoelectric transducers and the level of acoustic pressure of the difference sounds is not linear. In that respect, linear transmission can be achieved with a compensation circuit.

Linearization of the Frequency Characteristic

Frequency-dependent amplitude errors in the transmission system are compensated by a frequency characteristic linearization procedure which is required in particular when using piezoelectric transducers with a strongly non-linear frequency characteristic. Distortion removal can be effected prior to modulation in the low-frequency range or after modulation in the ultrasonic range. Distortion removal after modulation enjoys the advantage that in that way the operating reserve of the modulator is not limited when a frequency range is raised.

Area-Related Distortion Removal

The difference sound wave occurs in the radiated ultrasound cone. The cross-section of the cone in that case has an influence on the resulting audio frequency characteristic. The audible signal occurs at a boundary surface or interface which is put into the sound beam. In that situation the lower limit frequency depends on the cross-sectional area of the article put into the beam. In order to achieve a linear frequency characteristic for a reflector at a wall, distortion removal which is matched to the area of the reflector is necessary.

Distance-Related Distortion Removal

The maximum in terms of the acoustic pressure occurs at a given distance from the source. It arises for different audio frequencies at different spacings. Therefore, a linear frequency characteristic can be set for a given distance only by virtue of a specific distance-related distortion removal effect. Accordingly signal processing must include a specific distance-dependent frequency characteristic distortion removal effect, for a linear frequency characteristic.

Increase in the acoustic pressure by a large number of transducers

In order to produce a high ultrasound level, a relatively large number of transducers are connected in parallel.

The arrangement of the transducers plays a great part in this case: the transducers are arranged as densely as possible on a plate so that the low-note response or reproduction of the loudspeaker is quieter than in the case of an arrangement in which the same number of transducers are arranged in an annular array.

Modulation by Digital Signal Processing

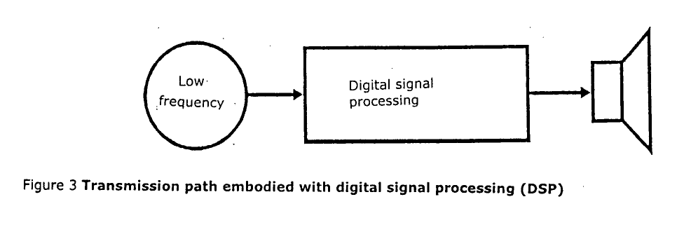

The described analog amplitude modulation procedure can also be implemented digitally. Multiplication of a sine oscillation (carrier) by a low-frequency signal, partial suppression of the carrier and suppression of the lower side band are possible, with a digital signal processor component—FIG. 3. Frequency characteristic contours can also be relatively easily implemented when using a digital signal processor.

Non-Linearity Parameters

The level of the audio acoustic pressure also depends inter alia on the non-linearity parameter of the medium. For air the parameter ε=1.2. For the medium water ε=3.5, for water with air bubbles, it is possible to specify an extreme value of ε=5,000. In comparison with the medium air, the acoustic pressure can be increased by the factor of 4,000. A suitable medium between the ultrasonic radiating device and the listener can increase the acoustic pressure of the audio signal.

The audio acoustic pressure can be increased by other measures. Due to the increasing steepening of the gradient of the wave front in the course of propagation, which is equivalent to the production of harmonics. In accordance with an energy balance sheet, the energy which is in the harmonics is not available for the difference sound wave. There is so-to-speak a flow of energy from the fundamental wave to the harmonics. If it is possible to brake that flow of energy, the audio acoustic pressure could be increased.

A Proposed Implementation in that Respect is as Follows:

A sound-transmitting medium contains small cavities which, together with the material, affords a multiplicity of Helmholtz resonators. The resonators are tuned to the first harmonic of the signal and thereby brake the flow of energy to higher harmonics. If the cavities are filled with a non-linear medium, for example a liquid, it is possible by virtue of that measure to achieve a higher value for the non-linearity parameter, whereby the acoustic pressure of the difference sounds was increased.

By means of that technology, it is possible to construct reflectors which passively amplify the acoustic pressure of the difference sounds.

By virtue of the described “attenuation plate”, for an ultrasonic loudspeaker which is fitted into the head support of a motor vehicle, it is possible to achieve a higher level of audio sound with at the same time reduced ultrasound.

For cable-less headsets, it would be possible for inaudible ultrasound to be wirelessly transmitted and for the difference sounds to be brought to a high level by way of the above-described absorber.

Practical Uses

As audible sound occurs only in the superimposition zone of the mixed ultrasonic signals, almost punctiform “projection” of the sound is possible by virtue of the spatial separate irradiation of carrier and side band signals by way of specific transducers. Irradiation of both signals by way of a single transducer or a transducer array in contrast modifies the punctiform characteristic into a linear characteristic along the direction of propagation of the ultrasound.

Practical uses of the ultrasonic loudspeaker are primarily those in which use is made of the strong directional effect of the loudspeaker. In regard to uses a)-e) an absorbent material behind the region to be acoustically irradiated provides for preventing rearward reflection of the ultrasound.

a) Art objects which “speak” acoustic irradiation of an art object in such a way that the sound is audible only in the immediate vicinity of the object. The transducer can be arranged for example above the object and is audible only within a small region around the object. Acoustic irradiation of the surrounding area does not occur as a result.

b) Active noise compensation for a motor vehicle, aircraft, bus or train; a microphone is used to record and analyze the ambient noise. Using an electronic circuit, a signal of opposite phase is produced and irradiated with the ultrasound transmission method in a directed mode and in dependence on the seating position. Superimposition of the sound with the counter-sound produced causes a reduction in ambient noise.

c) Conference systems for spatially addressable sound emission in various languages: in conference rooms and halls, the individual seat positions are selectively radiated with sound without the respective neighbour being disturbed. Various languages can be transmitted in that way simultaneously and without using headsets.

d) A loudspeaker in an aircraft, bus, train as a headset substitute: the strong directional effect of the ultrasonic loudspeaker makes it possible to produce sounds with loudspeakers instead of with headsets. That is made possible by the implementation of electrically or mechanically pivotable radiating devices and permits “audio on demand”.

e) Directed sound emission on the stage (prompter).

f) In a motor vehicle as an addressable loudspeaker (transducers mounted in the head support or the roof are controllable by way of an operating panel with a matrix display).

g) Sound irradiation of computer workstations at the monitor. Transducers are mounted around the picture tube of the monitor. The sound is thus audible only directly in front of the monitor.

h) “Ultrasonic wallpaper” or ultrasonic ceiling for active noise compensation in the home, function see above.

i) Surround loudspeakers: utilising wall reflections: “projection” of the surround information on to the room walls at which virtual sound sources are to occur. The rear boxes therefore do not necessarily have to be set up behind the listener.

j) Sound production in connection with PA-uses: acoustic “illumination” of quite specific areas. In that respect distinction in relation to the surrounding regions (audio on demand).

k) Hands-free device (for telephoning in a motor car): due to the strong directional effect of the loudspeaker, if the microphone is appropriately mounted, it can be provided that no acoustic feedback occurs between loudspeaker sound and the picked-up microphone sound. A combination of ultrasonic loudspeaker and directional microphone for avoiding acoustic feedback: the loudspeaker is arranged for example above the listener while the directional microphone is directed frontally towards the person speaking. The strongly directed sound of the ultrasonic loudspeaker does not reach the microphone so that there cannot be any acoustic feedback effect (for example in TV studios involving questions from the audience).

l) If an ultrasonic loudspeaker is installed at each seat position, a telephone conversation can be carried on at each seat position without the telephone set having to be brought to that place.

In the case of the method described herein for the reproduction of audio sound, exclusively inaudible ultrasound is irradiated into the air by way of a special transducer.

Due to non-linear effects in the air, audible sound is produced with a high level of acoustic pressure and the superimposition of two ultrasonic waves. The frequency of the ultrasound, which is high in comparison with ordinary audio signals, means that the emission of sound is effected in a strongly spatially directed manner, by virtue of its short wavelength and the transducer dimensions which are large in relation thereto. The frequency dependency of the directional characteristic of conventional loudspeakers (spherical radiating devices at low frequencies and directional radiating devices at high frequencies) scarcely arises with this loudspeaker.

The method combines low-frequency audio sound with the strong directional characteristic of ultrasound. The directional characteristic of the loudspeaker is thus virtually independent of the signal frequency.

Reduction in Distortion Phenomena upon Amplitude Modulation

Radiation of the modulated signal is effected with ultrasonic transducers. If the signal is a double side band-modulated AM signal, distortion effects caused by the principle involved can be reduced, in the following manner:
1. by narrow-band transducers of high quality,
2. in the case of wide-band transducers by an upstream-connected filter.

The filter is not required in the case of narrow-band transducers as the transmission function of the transducers is already equivalent to that of a narrow-band filter.

The system is to be tuned in such a way that the carrier frequency comes to lie approximately on the −6 dB point of the filter flank. Cutting off the lower side band causes a reduction in the distortion effects.

Temperature-dependent drift of the filter flank of narrow-band transducers and filters has to be compensated by adjustment of the carrier frequency. Adjustment of the carrier frequency is effected as far as possible in signal intervals.

In the case of speech reproduction, signal filtering of the audio signal to be modulated should be effected to increase speech comprehensibility. The filter is to be designed in such a way that attenuation 3 dB/oct. occurs from the signal frequency of 1 kHz.

Reduction in Distortion Effects as a Consequence of Transducer Geometry

If the transducer dimensions exceed the value of about one-quarter of the lowest low-frequency wavelength to be emitted, distortion effects increasingly occur in the near-range field of the transducer, due to signal transit time differences. The dimensions of the transducer should therefore be less than the specified wavelength.

Additional Supplement for Technical Implementation of Modulation

A still more strongly directed audio band radiation effect can be achieved as follows:

The acoustic pressure of the audio band depends on the product of the acoustic pressures of the carrier signal and the side band. By increasing the acoustic pressure—either of the carrier or the side band—the resulting acoustic pressure is increased in the audio frequency range. Radiating a wide frequency range with a high acoustic pressure gives rise to certain difficulties.

Radiation of carrier and side band by way of a transducer or a transducer group makes heavy demands on the transducers. By virtue of almost identical radiation conditions in respect of carrier and side band, the audio wave occurs in the entire signal superimposition region. That results in a relatively wide radiation effect. A still sharper directional effect can be achieved by emitting carrier and side band by way of separate transducers:

A special, very narrow-band, sensitive and highly directional transducer produces the carrier signal while the side band is superimposed with a wider-band transducer/transducer array. As the audio acoustic pressure is formed by the product of the two ultrasonic acoustic pressures to be superimposed, it is possible, by way of the acoustic pressure of the carrier, to adjust the acoustic pressure of the audio wave within wide limits and at the same time to reduce the level of the ultrasonic carrier, with low levels of volume. The superimposition of the sound waves and the production of mixed products however occurs only in the region where both sound waves so-to-speak fill the space. Due to the very strong possible directional characteristic of the carrier radiating device, that also results in a highly pronounced directional effect for the audio wave.

Absorption of the Ultrasonic Signal by an Ultrasonic Filter

To produce the audio signal from the modulated ultrasonic signal, a given distance is required, along which the wave is demodulated in the air. When the ultrasound has covered the distance required, a filter which is transmissive in respect of audio frequencies but non-transmissive in respect of ultrasound provides that the audio wave is admittedly well audible, but the ultrasonic signal is strongly damped. The filter has no significant effect on the directional characteristic of the transducer.

The filter must be such that it strongly damps frequencies above the audible range while audio frequencies experience only a slight damping effect. It is more appropriately arranged at the end of the generation zone.

As a long generation zone is required for low audio frequencies the lower limit frequency of the audio signal can be varied by a variation in the spacing between the transducer and the absorber.

Enrichment of the Sound Image by Psychoacoustic Effects

The lower the frequency of the audio wave demodulated in air is, the correspondingly lower is the acoustic pressure of the wave, in relation to constant acoustic pressure of the ultrasonic waves. For reasons of physics therefore low frequencies can be only very quietly reproduced.

In order to give the subjective impression of reproducing deep sounds which objectively are not present at all, it is possible by means of signal processing to produce a given harmonic spectrum which gives rise to that impression. Pre-distortion of the audio signal is required for that purpose. The modulator includes a circuit which performs that function.

Further Uses

Virtual Loudspeaker

In order to cause a sound object to apparently move in space, it is necessary, with conventional loudspeaker technology, to move the loudspeaker in space. That effect can be more effectively achieved with the ultrasonic loudspeaker.

By making use of the reflecting properties for ultrasound of surfaces which are hard in relation to sound, it can be provided that reflection of the ultrasonic loudspeaker at a wall or the like is perceived similarly to a light beam which is reflected in a mirror, and that therefore gives a virtual source. For example, two forms of implementation are possible:
1. Rotatably and pivotably suspended US-loudspeaker,
2. Fixedly suspended US-loudspeaker which radiates on to a movably mounted reflector.

Spatial Signal Motion by Means of a Travelling Transducer

When the listener is moving, for example on a travelator, escalator and the like, the audio signal can also be caused to move along, by virtue of pivotal movement of the transducer, so that only the moving listener is subjected to the effect of sound, but not the surrounding region in space.

Accompanying movement of the audio sound can also be effected by switching on ultrasonic radiating devices which are disposed above the listener, such switching-on effect being synchronised with the speed of travel of the travelator/escalator; the ultrasonic radiating devices only ever radiate sound into the regions in space in which the listener is moving at that time.

Spatial Accompanying Signal Motion by a Phased Array

By means of targetedly actuating individual transducer elements of an array, it is possible to produce accompanying spatial signal motion (in the case of the ultrasonic loudspeaker having a strong directional characteristic) without in that situation moving the ultrasonic radiating device. This method is a combination of the “phased array” technology and the above-described “ultrasonic loudspeaker”.

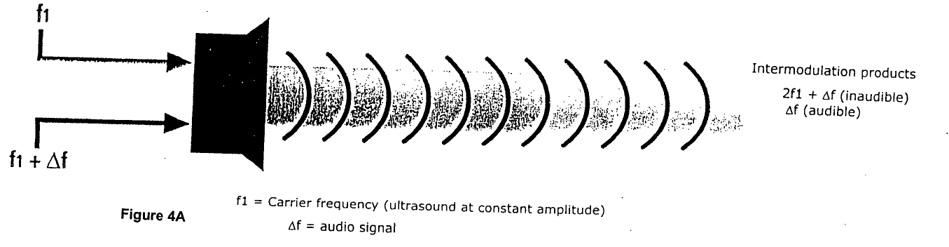

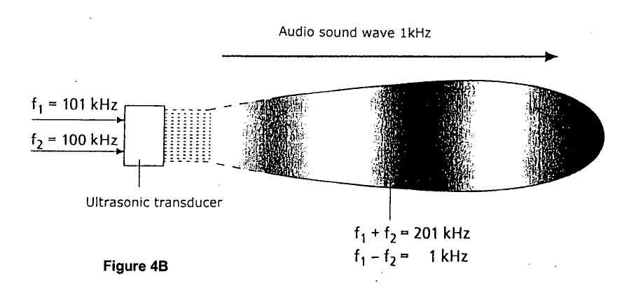

FIGS. 4a and 4b show the propagation of an audio sound wave produced by an ultrasonic transducer. In this case for example the frequencies f₁=101 kHz and f₂=100 kHz are simultaneously radiated by the ultrasonic radiating device (ultrasonic transducer). Now, similarly to a (non-linear) mixer stage of an AM medium-wave receiver the mixed products f₁+f₂=201 kHz and f₁−f₂=1 kHz and multiples thereof are now produced in the ultrasonic beam in air. The sum frequency f₁ and f₂=201 kHz is not audible to a human being, but the difference frequency f₁−f₂=1 kHz is. It can now be easily imagined that f, is modulated, with the audio frequency range Δf=100 . . . 20 kHz to f₁=100 kHz+Δf. Then, inter alia also precisely the audio frequency 100 Hz . . . 20 kHz occurs in the ultrasonic beam due to the mixing effect at the non-linearity of the air, in which case this involves a similarly strong focusing effect as is predetermined by the ultrasonic beam.

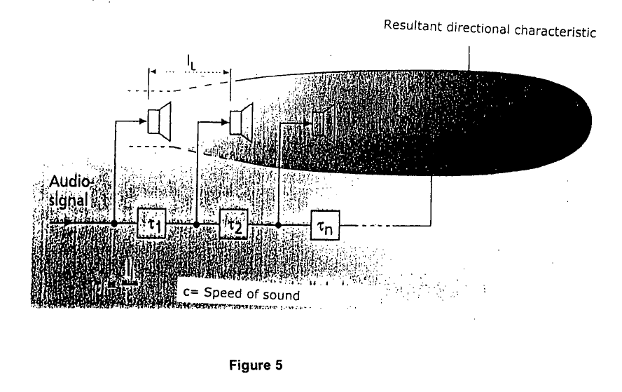

In the mixing zone of the ultrasonic beam there are virtual audio sound sources (virtual loudspeakers) which are added up in the direction of the progressing ultrasound for ultrasound and audio sound are propagated at the same speed of sound (340 m/s). That effect can be represented on a model. Small loudspeakers are mounted in closely adjacent relationship on a bar, which can all radiate audio sound as spherical radiating devices (FIG. 5) and which are actuated with the same audio signal in time-delayed relationship. The time delay t between two loudspeakers is so selected that it exactly corresponds to the time that the sound wave requires to go from one loudspeaker to the next. It can be determined by the relationship t=c/1_{L} c=speed of sound). The sound from the first loudspeaker is amplified by the second and so forth. A very strong focusing effect in respect of the audio sound occurs due to the multiplicity of loudspeakers (a virtually infinite number of virtual sound sources are produced in the ultrasonic beam), which loudspeakers are switched on in dependence on location with the transit time of the sound.

The audio sound in the ultrasonic beam according to the invention occurs in the ultrasonic beam itself. In contrast to the radiation of sound by a conventional loudspeaker, it initially becomes louder with increasing distance until the ultrasound level has dropped away to such an extent that the non-linear effect of the air no longer acts and thus no more components are added to audio sound production. The length of the active zone of audio sound production in the ultrasonic beam determines the lower limit frequency of the directed audio sound source. There must be at least so many virtual sound sources that the active zone is several wavelengths long at the lower limit frequency. Therefore audio frequencies below 100 Hz require large distances from the listener to the ultrasonic radiating device (and thus also high levels of output power). One approach in this respect is afforded by using psychoacoustic signal processing, as described hereinbefore.

It follows from the two effects described that the level and the lower reproduction frequency of the audio signal are dependent on location. The high ultrasonic level which is necessary in principle to produce the audio sound has to be present only in the active zone of the ultrasonic beam. Once the directed audio sound beam has been produced, the ultrasonic component can be eliminated with an acoustic low pass filter (audio sound-transmissive ultrasonic absorber).

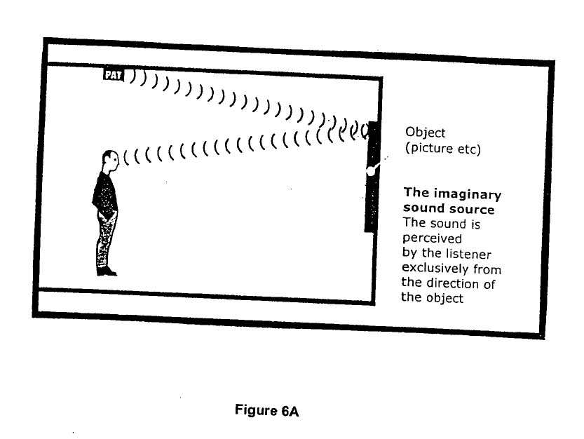

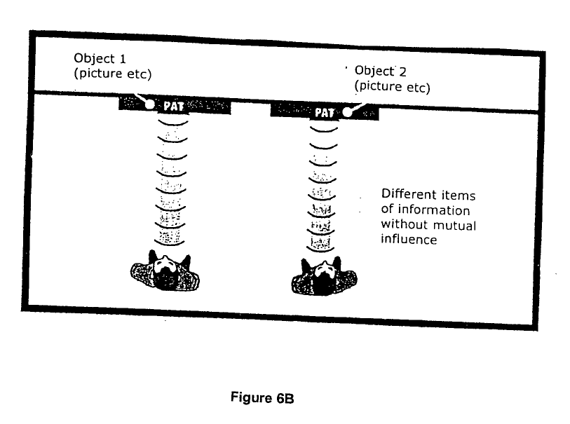

FIGS. 6a and 6b show typical examples of use of the ultrasonic radiating device which is arranged under a ceiling and which directs the ultrasonic beams modulated with audio signals, on to a wall of which an ultrasound-absorbent coating (ultrasound-reflection covering) is so adapted that ultrasound is absorbed. The audio signals which are then reflected are ultrasound-free and can be heard by the person in front of the wall.

An ordinary ultrasonic transducer can be used for the ultrasonic transducers themselves. However, ultrasonic foil transducers are also particularly suitable, which in the manner of a capacitor (electret) transducer have a foil and a counter-electrode which is suitably designed (with grooves or holes).

The alternative configuration is also advantageous, in which the position where a listener to whom sound is to be radiated is disposed is ascertained by means of a distance-measuring device in relation to an ultrasonic measuring device. If the listener is in a critical region of the ultrasonic beam, which could be harmful to health, ultrasound reproduction is switched off so that the respective person (or the animal) is not exposed to high levels of ultrasound. If the ultrasound is to be directed on to a given region and if that region is also still moving (that is for example the case with a single listener who is moving on a stage and who is to be radiated with sound), then it is advantageous in that respect if there is provided a device by means of which the listener intended to receive the sound can currently be located so that the sound radiation effect is preferably implemented only to the located region. That can be effected for example by the listener intended to receive the sound bearing a transmitting device with navigation (for example GPS) and thus constantly transmitting his own navigational data to a receiver device which in turn is used to control the pivoting movement of the ultrasonic beam. The listener who is to receive the sound could also be fitted with a so-called TAG identifier, the precise position of which is ascertained by a suitable interrogator (interrogation unit for the TAG), with which then in turn the pivoting movement of the ultrasonic beams is controlled. However it is also possible to use all other technical options for locating an individual region or a plurality of regions in order to control the pivoting movement of an ultrasonic beam so that audio reproduction can then only ever be heard in the desired narrow region but not outside the desired region.

Such uses are particularly advantageous in a theater (for the prompter) or in a television studio in relation to a TV show when the presenter who is moving across the stage is to receive instructions which are not to be audible to the rest of the public.

The pivoting movement of the ultrasonic beam can be implemented with the different technological procedures described in this application, that is to say by pivoting the ultrasonic radiating devices or by means of a pivotable reflector or by the so-called “phased array” control, with the ultrasonic beams being directionally electronically determined.

While the foregoing description and drawings represent the present invention, it will be obvious to those skilled in the art that various changes may be made therein without departing from the true spirit and scope of the present invention.

1-30. (canceled)

31. A method of reproducing audio sound by an ultrasound-producing device comprising the steps of:
linking the audio signal to be produced by side band amplitude modulation to a carrier signal in the ultrasonic frequency range;
subjecting the modulated ultrasonic signal to dynamic error compensation and then passing said signal to an ultrasonic transducer; and
reducing the amplitude of the ultrasonic carrier signal at said transducer.

32. The method as set forth in claim 31 wherein the ultrasonic signal is suppressed in modulation breaks, when therefore no audio signal is to be reproduced.

33. The method as set forth in claim 31 wherein the low frequency audio signal which is to be reproduced is subjected to frequency characteristic linearization prior to modulation.

34. The method as set forth in claim 31 wherein the audio signal to be reproduced is subjected to double side band amplitude modulation or single side band amplitude modulation.

35. The method as set forth in claim 31 including the step of suppressing the ultrasonic carrier by an amount of between about 8 and 20 dB.

36. The method of claim 35 wherein the ultrasonic carrier is suppressed by about 12 dB.

37. The method as set forth in claim 31 wherein the frequency of the ultrasonic carrier signal is in the range of between about 40 kHz and 500 kHz.

38. The method as set forth in claim 31 wherein in a double side band amplitude modulation procedure the lower side band is suppressed.

39. The method as set forth in claim 31 including the step of effecting distortion removal (frequency characteristic linearization) after amplitude modulation.

40. The method as set forth in claim 31 wherein a plurality of ultrasonic transducers are provided which are connected in parallel.

41. The method as set forth in claim 40 wherein the transducers are arranged as densely as possible on a plate.

42. The method as set forth in claim 31 wherein modulation is effected by a digital signal processor.

43. The method as set forth in claim 31 wherein a water-air bubble mixture is arranged in the ultrasound propagation path.

44. The method as set forth in claim 43 wherein the water-air bubble mixture is provided in a headset earpiece.

45. The method as set forth in claim 31 wherein, arranged in the path of propagation of the ultrasonic beams, is a sound-transmissive medium containing cavities which together with the medium material have a plurality of Helmholtz resonators which are tuned to the first harmonic of the ultrasonic signal.

46. The method as set forth in claim 45 wherein the cavities are filled with a non-linear medium.

47. The method as set forth in claim 31 wherein a plurality of ultrasonic transducers are arranged in an annular array.

48. The method as forth in claim 31 wherein the ultrasonic carrier signal and the side band signal are fed to separate transducers.

49. The method as set forth in claim 31 wherein the aperture angle of an ultrasonic transducer is approximately in the range of between 0.5 and 10°, preferably 1°.

50. The method as set forth in claim 31 including subjecting the audio signal to a pre-distortion effect.

51. The method as set forth in claim 31 including pivoting the ultrasonic beam into a desired direction.

52. The method as set forth in claim 51 including pivoting the ultrasonic beam by a mechanical pivoting device for the ultrasonic radiating device and/or electronic actuation of the ultrasonic radiating devices in the manner of a so-called “phased array” and/or there is a pivotable reflector which reflects the ultrasound into a desired direction.

53. The method as set forth in claim 31 wherein the ultrasonic apparatus forms an ultrasonic wallpaper so that, when listening, the impression is that the sound is coming directly from the wall or from the wallpaper on the wall.

54. The method as set forth in claim 31 wherein the carrier band of the ultrasonic radiating band and the ultrasonic beam side band are produced with different transducers.

55. The method as set forth in claim 31 wherein the audio LF signal is subjected to psychoacoustic pre-processing (in particular psychoacoustic pre-distortion) and there are provided suitable means therefor.

56. The method as set forth in claim 31 including an acoustic travelator so that when a listener is moving past an ultrasonic transducer only the moving listener is radiated with sound but not the surrounding area in space.

57. The method as set forth in claim 31 including at least one ultrasonic transducer which exclusively or additionally to ultrasonic irradiation serves as a transmitting and/or receiving device of a distance-measuring device based on ultrasound.

58. The method of claim 31 wherein the properties of the audio signal to be reproduced, in particular the lower limit frequency thereof, are determined by the magnitude of the reflection area in order thereby to compensate for frequency characteristic linearization or distortion removal of the audio signal.

59. The method as set forth in claim 31 wherein the audio signal to be reproduced is subjected in a modulator to frequency and/or phase modulation.

60. An apparatus for reproducing audio sound using ultrasound comprising:
means for linking an audio signal to be reproduced by side band amplitude modulation to a carrier signal in the ultrasonic frequency range;
means for subjecting the modulated ultrasonic signal to dynamic error compensation and then passing said signal to an ultrasonic transducer; and
means for reducing the amplitude of the ultrasonic carrier signal.

61. The apparatus as set forth in claim 60 including means for suppressing the ultrasonic signal in modulation breaks, when therefore no audio signal is to be reproduced.

62. The apparatus as set forth in claim 60 including means for subjecting the audio signal to be reproduced to frequency characteristic linearization prior to modulation.

63. The apparatus as set forth in claim 60 wherein the audio signal to be reproduced is subjected to double side band amplitude modulation or signal side band amplitude modulation.

64. The apparatus as set forth in claim 60 including means for suppressing the ultrasonic carrier by an amount of between about 8 and 20 db.

65. The apparatus as set forth in claim 64 including means for suppressing the ultrasonic by about 12 db.

66. The apparatus as set forth in claim 60 wherein the frequency of the ultrasonic carrier is in the range of between about 40 kHz and 500 kHz.

67. The apparatus as set forth in claim 60 wherein in a double side band modulation procedure, means are provided for suppressing the lower side band.

68. The apparatus as set forth in claim 60 including means for effecting distortion removal (frequency characteristic linearization) after amplitude modulation.

69. The apparatus as set forth in claim 60 including a plurality of ultrasonic transducers which are connected in parallel.

70. The apparatus as set forth in claim 69 wherein the transducers are arranged as densely as possible on a plate.

71. The apparatus as set forth in claim 60 wherein modulation is effected by a digital signal processor.

72. The apparatus as set forth in claim 60 wherein a water-air bubble mixture is arranged in the ultrasound propagation path.

73. The apparatus as set forth in claim 72 wherein the water-air bubble mixture is provided in a headset earpiece.

74. The apparatus as set forth in claim 60 wherein, arranged in the path of propagation of the ultrasonic beams is a sound-transmissive medium containing cavities which together with the medium material have a plurality of Helmholtz resonators which are preferably tuned to the first harmonic of the ultrasonic signal.

75. The apparatus as set forth in claim 60 wherein the cavities are filled with a non-linear medium.

76. The apparatus as set forth in claim 60 wherein a plurality of ultrasonic transducers are arranged in an annular array.

77. The apparatus as set forth in claim 60 wherein the ultrasonic carrier signal and the side band signal are fed to separate transducers.

78. The apparatus as set forth in claim 60 wherein the aperture angle of an ultrasonic transducer is approximately in the range of between 0.50 and 10°.

79. The apparatus as set forth in claim 78 wherein the aperture angle is 1°.

80. The apparatus as set forth in claim 60 including means for subjecting the audio signal to a pre-distortion effect.

81. The apparatus as set forth in claim 60 including means for pivoting the ultrasonic beam by a mechanical pivoting device for the ultrasonic radiating and/or electronic actuation of the ultrasonic radiating devices in the manner of a so-called “phased array” and/or there is a pivtotable reflector which reflects the ultrasound into a desired direction.

82. The apparatus as set forth in claim 60 wherein the ultrasonic apparatus forms an ultrasonic wallpaper so that, when listening, the impression is that the sound is coming directly from the wall or from the wallpaper on the wall.

83. The method as set forth in claim 60 wherein the carrier band of the ultrasonic radiating beam and the ultrasonic beam side band are produced with different transducers.

84. The apparatus as set forth in claim 60 including means for subjecting the audio LF signal to psychoacoustic pre-processing, particularly psychoacoustic pre-distortion.

85. The apparatus as set forth in claim 60 including an acoustic travelator so that when a listener is moving past an ultrasonic transducer only the moving listener is radiated with sound but not the surrounding area in space.

86. The apparatus as set forth in claim 60 wherein the properties of the audio signal to be reproduced, in particular the lower limit frequency thereof, are determined by the magnitude of the reflection area in order thereby to compensate for frequency characteristic linearization or distortion removal of the audio signal.

87. The apparatus as set forth in claim 60 wherein the audio signal to be reproduced is subjected in a modulator to frequency and/or phase modulation.

88. In a method of using ultrasonic reproduction apparatus as set forth in claim 60 including the step of using said apparatus in an art exhibition and/or in a museum or for active noise compensation and/or in conference systems and/or as a loudspeaker as a headset substitute and/or for directed sound radiation on a stage (prompter) and/or as an addressable loudspeaker and/or for sound radiation of computer workstations and/or as a surround loudspeaker and/or for acoustic irradiation of quite specific zones and/or in a hands-free device.

89. In a method of using ultrasonic apparatus as set forth in claim 60 including the step of using said apparatus for sound irradiation of a region through which the listener is moving or through which the listener is moved, wherein the reproduction level of the ultrasonic signal is always directed.

90. The method according to claim 31, further comprising subjecting the compensated ultrasonic signal to frequency characteristic linearization.

91. The apparatus according to claim 60, further comprising means for subjecting the compensated ultrasonic signal to frequency characteristic linearization.

92. The apparatus according to claim 60, further comprising a frequency characterization linearizer that performs frequency characteristic linearization on the compensated ultrasonic signal, wherein said apparatus is used for sound irradiation of a region through which the listener moves, wherein the reproduction level of the ultrasonic signal is always directed.
